(19) United States
(12) Patent Application Publication
(10) Pub. No.: US 2019/0009509 A1
(43) Pub. Date: Jan. 10, 2019

(54) FILM WITH INLAY DÉCOR

(71) Applicant: Klöckner Pentaplast GmbH, Heiligenroth (DE)

(72) Inventors: Jordi GARRIGA, Saint Celoni (ES); Rainer SCHLICHT, Feldkirchen (DE)

(21) Appl. No.: 16/030,657

(22) Filed: Jul. 9, 2018

(30) Foreign Application Priority Data
Jul. 10, 2017 (DE) 102017115380.2

(51) Int. Cl. B32B 27/20; B32B 27/08; B29C 47/00; B29C 47/06; B29C 43/00; B29C 43/24; B29C 43/30

(52) U.S. Cl. CPC B32B 27/20; B32B 27/08; B29C 47/0004; B29C 47/065; B29K 2105/0032; B29C 43/24; B29C 43/305; B32B 2307/538; B29C 43/003

(57) ABSTRACT

A mono- or multilayer film is provided that includes at least one decorative layer having a matrix formed from a first polymeric material and striations of a second polymeric material embedded into the matrix formed from the first polymeric material. The invention further includes processes to form the inventive films, as well as articles formed therefrom.

### CROSS REFERENCE TO RELATED APPLICATIONS

This application claims priority to parent German Application 10 2017 115 380.2, filed Jul. 10, 2017, which is hereby incorporated herein by reference in its entirety.

### FIELD OF THE INVENTION

The present invention relates to a mono- or multilayer film.

### BACKGROUND OF THE INVENTION

The prior art discloses a wide variety of different kinds of polymer films for the packaging of consumer articles and food and drink products. Large amounts of decorative films are used for the coating of furniture and floorcoverings, such as laminate. Coloured, decorated and printed films are taking on an increasing role in the packaging of food and drink products and consumer articles. Film decorations are produced by printing, which entails considerable extra expenditure according to the complexity of the decoration. Moreover, the print is prone to damage by mechanical action. In the case of use for food and drink products, it is additionally necessary to ensure that no dyes and printing additives can migrate from the decorative print into the food or drink product. For the above reasons, it is standard practice to laminate a transparent protective film onto a film equipped with a decorative print, or to cover it with a lacquer.

### SUMMARY OF ADVANTAGEOUS EMBODIMENTS OF THE INVENTION

The problem addressed by the present invention is that of providing a decorative film for which no printing is required for manufacture thereof, and the decoration of which is insensitive to mechanical action. Furthermore, the decorative film is to be suitable for direct contact with food and drink products.

This problem is solved by a mono- or multilayer film having at least one decorative layer comprising a matrix composed of a first polymeric material and striations of a second polymeric material embedded into the matrix.

### BRIEF DESCRIPTION OF THE FIGURES

The invention is elucidated in detail hereinafter with reference to figures. The figures show:

FIG. 1 a schematic sectional view of a monolayer film;

FIG. 2 a schematic sectional view of a decorative layer containing striations of the film;

FIG. 3 a schematic sectional view of a trilayer film having two outer decorative layers containing striations;

FIG. 4 a schematic sectional view of a tetralayer film having two decorative layers containing striations;

FIG. 5 a first example of a texture of a film;

FIG. 6 a diagram of the directionality of the texture shown in FIG. 5;

FIG. 7 a second example of a texture of a film;

FIG. 8 a diagram of the directionality of the texture shown in FIG. 7;

FIG. 9 a third example of a texture of a film;

FIG. 10 a diagram of the directionality of the texture shown in FIG. 9;

FIG. 11 a fourth example of a texture of a film; and

FIG. 12 a diagram of the directionality of the texture shown in FIG. 11.

### DETAILED DESCRIPTION OF ADVANTAGEOUS EMBODIMENTS OF THE INVENTION

Advantageous embodiments of the film according to the invention are characterized in that
the striations have a stripe-shaped contour,
the striations have a stripe-shaped contour with swirls;
the striations have a stripe-shaped contour with randomly varying width;
the striations have a stripe-shaped contour with a visually fluid transition to the matrix;
a longitudinal axis of the striations is oriented parallel to a machine direction of the film;
the striations in a transverse direction of the film have a width of 0.5 to 20 mm, 0.5 to 15 mm, 0.5 to 10 mm or 0.5 to 5 mm;
the at least one decorative layer containing striations forms a surface of the film;
the film has a thickness of 30 to 3000 μm;
the film has a thickness of 30 to 2000 μm, 30 to 1500 μm, 30 to 1200 μm, 50 to 2000 μm, 50 to 1500 μm, 50 to 1200 μm, 100 to 1500 μm, 200 to 1500 μm, 50 to 500 μm, 50 to 400 μm or 50 to 300 μm;
the thickness of the at least one decorative layer containing striations is 1 to 1000 μm, 1 to 800 μm, 1 to 600 μm, 1 to 400 μm, 1 to 200 μm, 1 to 100 μm or 1 to 50 μm;
a thickness of the at least one decorative layer containing striations, based on the thickness of the film, is 1 to 15%;
the film is thermoformable;
the film has two, three, four, five, six, seven, eight, nine or ten layers;
the film comprises two or more decorative layers containing striations;
the film has two layers and comprises an opaque carrier layer;
the film has two layers and comprises a coloured carrier layer;
the film has three layers and comprises a first decorative layer containing striations, an opaque core layer and a second decorative layer containing striations, where the opaque core layer is disposed between the first and second decorative layers containing striations;
the film has three layers and comprises a first decorative layer containing striations, a coloured core layer and a second decorative layer containing striations, where the coloured core layer is disposed between the first and second decorative layers containing striations;
the film has four layers and comprises a first decorative layer containing striations, a first opaque core layer, a second opaque core layer and a second decorative layer containing striations, where the first and second opaque core layers are disposed between the first and second decorative layers containing striations;
the film has four layers and comprises a first decorative layer containing striations, a first coloured core layer, a second coloured core layer and a second decorative layer containing striations, where the first and second coloured core layers are disposed between the first and second decorative layers containing striations;
the at least one decorative layer containing striations is disposed between two or more than two outer layers, where the outer layers present on at least one side of the decorative layer containing striations are transparent;
the at least one decorative layer containing striations is disposed between two or more than two outer layers, where one of the outer layers present on at least one side of the decorative layer containing striations is transparent and sealable;
the volume ratio of the striations to the matrix is 0.5% to 15% by volume;
the volume ratio of the striations to the matrix is 0.5% to 10% by volume, 0.5% to 8% by volume, 0.5% to 6% by volume or 0.5% to 4% by volume;
the matrix of the decorative layer containing striations is transparent;
the matrix of the decorative layer containing striations has an optical transmission of ≥50%, ≥60%, ≥70%, ≥80% or ≥90%;
the first polymeric material of the decorative layer containing striations is transparent;
the second polymeric material of the decorative layer containing striations is transparent;
the second polymeric material of the decorative layer containing striations comprises one or more dyes or colour pigments;
the second polymeric material of the decorative layer containing striations comprises a brown dye or brown colour pigments;
the second polymeric material of the decorative layer containing striations comprises a white dye or white colour pigments;
the second polymeric material comprises particles of a mineral material, for example mica;
the second polymeric material of the decorative layer containing striations comprises particles of a metallic material, for example aluminium;
the first polymeric material of the decorative layer containing striations comprises one or more dyes or colour pigments;
the first polymeric material of the decorative layer containing striations comprises a brown dye or brown colour pigments;
the first polymeric material of the decorative layer containing striations comprises a white dye or white colour pigments;
the first polymeric material of the decorative layer containing striations comprises particles of a mineral material, for example mica;
the first polymeric material of the decorative layer containing striations comprises particles of a metallic material, for example aluminium;
the first polymeric material of the decorative layer containing striations is transparent and the second polymeric material comprises one or more dyes or colour pigments;
the second polymeric material of the decorative layer containing striations is transparent and the first polymeric material comprises one or more dyes or colour pigments;
the first and second polymeric materials of the decorative layer containing striations each comprise one or more dyes or colour pigments, where the dyes or colour pigments of the first and second polymeric materials have different colours and/or are present in different concentrations in the first and second polymeric materials;
the first and second polymeric materials of the decorative layer containing striations are transparent and the first polymeric material comprises transparent pigments having a refractive index different from the first polymeric material;
the first and second polymeric materials of the decorative layer containing striations are transparent and the second polymeric material comprises transparent pigments having a refractive index different from the first polymeric material;
the film comprises two or more decorative layers containing striations, where the two or more decorative layers consist of different polymeric materials;
the film comprises two or more decorative layers containing striations, where two or more decorative layers consist of identical polymeric materials;
the film comprises two or more decorative layers containing striations, where the two or more decorative layers comprise different dyes or colour pigments;
the first and second polymeric materials of the decorative layer containing striations have respective melt mass flow rates MFI₁ and MFI₂ where

0.2≤2|MFI₁−MFI₂|/(MFI₁+MFI₂)≤2.0;
the first and second polymeric materials of the decorative layer containing striations have respective melt mass flow rates MFI₁ and MFI₂ where

0.3≤2|MFI₁−MFI₂|/(MFI₁+MFI₂)≤2.0;
the first and second polymeric materials of the decorative layer containing striations have respective melt mass flow rates MFI₁ and MFI₂ where

0.4≤2|MFI₁−MFI₂|/(MFI₁+MFI₂)≤2.0;
the first and second polymeric materials of the decorative layer containing striations have respective melt mass flow rates MFI₁ and MFI₂ where

0.5≤2|MFI₁−MFI₂|/(MFI₁+MFI₂)≤2.0;
the first and second polymeric materials of the decorative layer containing striations have respective melt mass flow rates MFI₁ and MFI₂ where

0.6≤2|MFI₁−MFI₂|/(MFI₁+MFI₂)≤2.0;
the first and second polymeric materials of the decorative layer containing striations have respective melt mass flow rates MFI₁ and MFI₂ where

0.7≤2|MFI₁−MFI₂|/(MFI₁+MFI₂)≤2.0;
the first and second polymeric materials of the decorative layer containing striations have respective melt mass flow rates MFI₁ and MFI₂ where

0.8≤2|MFI₁−MFI₂|/MFI₁+MFI₂)≤2.0;
the first and second polymeric materials of the decorative layer containing striations have respective melt mass flow rates MFI₁ and MFI₂ where MFI₁>MFI₂ and

0.2≤2|MFI₁−MFI₂|/(MFI₁+MFI₂)≤2.0;
the first and second polymeric materials of the decorative layer containing striations have respective melt mass flow rates MFI₁ and MFI₂ where MFI₁>MFI₂ and

0.3≤2|MFI₁-MFI₂|/(MFI₁+MFI₂)≤2.0;
the first and second polymeric materials of the decorative layer containing striations have respective melt mass flow rates MFI₁ and MFI₂ where MFI₁>MFI₂ and

0.4≤2|MFI₁−MFI₂|/(MFI₁+MFI₂)≤2.0;
the first and second polymeric materials of the decorative layer containing striations have respective melt mass flow rates MFI₁ and MFI₂ where MFI₁>MFI₂ and

0.5≤2|MFI₁−MFI₂|/(MFI₁+MFI₂)≤2.0;
the first and second polymeric materials of the decorative layer containing striations have respective melt mass flow rates MFI₁ and MFI₂ where MFI₁>MFI₂ and

0.6≤2|MFI₁−MFI₂|/(MFI₁+MFI₂)≤2.0;
the first and second polymeric materials of the decorative layer containing striations have respective melt mass flow rates MFI₁ and MFI₂ where MFI₁>MFI₂ and

0.7≤2|MFI₁−MFI₂|/(MFI₁+MFI₂)≤2.0;
the first and second polymeric materials of the decorative layer containing striations have respective melt mass flow rates MFI₁ and MFI₂ where MFI₁>MFI₂ and

0.8≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.2≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.3≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.4≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.5≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.6≤2|MFI₁−MFI₂/(MFI₁+MFI₂)≤2.0;
the first and second polymeric materials of the decorative layer containing striations have respective melt mass flow rates MFI₁ and MFI₂ where MFI₁<MFI₂ and

0.7≤2|MFI₁−MFI₂|/(MFI₁+MFI₂)≤2.0;
the first and second polymeric materials of the decorative layer containing striations have respective melt mass flow rates MFI₁ and MFI₂ where MFI₁<MFI₂ and

0.8≤2|MFI₁-MFI₂|/(MFI₁-MFI₂)≤2.0;
the first polymeric material of the decorative layer containing striations has a melt mass flow rate MFI₁ in the range from 1 to 150 g/10 min;
the first polymeric material of the decorative layer containing striations has a melt mass flow rate MFI₁ in the range from 10 to 150 g/10 min;
the first polymeric material of the decorative layer containing striations has a melt mass flow rate MFI₁ in the range from 20 to 150 g/10 min;
the first polymeric material of the decorative layer containing striations has a melt mass flow rate MFI₁ in the range from 30 to 150 g/10 min;
the first polymeric material of the decorative layer containing striations has a melt mass flow rate MFI₁ in the range from 40 to 150 g/10 min;
the first polymeric material of the decorative layer containing striations has a melt mass flow rate MFI₁ in the range from 50 to 150 g/10 min;
the first polymeric material of the decorative layer containing striations has a melt mass flow rate MFI₁ in the range from 50 to 100 g/10 min;
the first polymeric material of the decorative layer containing striations has a melt mass flow rate MFI₁ in the range from 20 to 50 g/10 min;
the second polymeric material of the decorative layer containing striations has a melt mass flow rate MFI₂ in the range from 1 to 150 g/10 min;
the second polymeric material of the decorative layer containing striations has a melt mass flow rate MFI₂ in the range from 1 to 100 g/10 min;
the second polymeric material of the decorative layer containing striations has a melt mass flow rate MFI₂ in the range from 1 to 50 g/10 min;
the second polymeric material of the decorative layer containing striations has a melt mass flow rate MFI₂ in the range from 1 to 40 g/10 min;
the second polymeric material of the decorative layer containing striations has a melt mass flow rate MFI₂ in the range from 1 to 30 g/10 min;
the second polymeric material of the decorative layer containing striations has a melt mass flow rate MFI₂ in the range from 1 to 20 g/10 min;
the second polymeric material of the decorative layer containing striations has a melt mass flow rate MFI₂ in the range from 1 to 10 g/10 min;
the second polymeric material of the decorative layer containing striations has a melt mass flow rate MFI₂ in the range from 4 to 8 g/10 min;
the at least one decorative layer containing striations comprises a third polymeric material;
the third polymeric material of the decorative layer containing striations comprises one or more dyes or colour pigments;
the third polymeric material of the decorative layer containing striations comprises a brown dye or brown colour pigments;
the third polymeric material of the decorative layer containing striations comprises a white dye or white colour pigments;
the third polymeric material of the decorative layer containing striations comprises particles of a mineral material, for example mica;
the third polymeric material of the decorative layer containing striations comprises particles of a metallic material, for example aluminium;
the first and third polymeric materials of the decorative layer containing striations have respective melt mass flow rates MFI₁ and MFI₃ where

0.2≤2|MFI₁−MFI₃|/(MFI₁+MFI₃)≤2.0;
the first and third polymeric materials of the decorative layer containing striations have respective melt mass flow rates MFI₁ and MFI₃ where

0.3≤2|MFI₁−MFI₃|/(MFI₁+MFI₃)≤2.0;
the first and third polymeric materials of the decorative layer containing striations have respective melt mass flow rates MFI₁ and MFI₃ where

0.4≤2|MFI₁−MFI₃|/(MFI₁+MFI₃)≤2.0;
the first and third polymeric materials of the decorative layer containing striations have respective melt mass flow rates MFI₁ and MFI₃ where

0.5≤2|MFI₁−MFI₃|/(MFI₁+MFI₃)≤2.0;
the first and third polymeric materials of the decorative layer containing striations have respective melt mass flow rates MFI₁ and MFI₃ where

0.6≤2|MFI₁−MFI₃|/(MFI₁+MFI₃)≤2.0;
the first and third polymeric materials of the decorative layer containing striations have respective melt mass flow rates MFI₁ and MFI₃ where

0.7≤2|MFI₁-MFI₃|/(MFI₁+MFI₃)≤2.0;
the first and third polymeric materials of the decorative layer containing striations have respective melt mass flow rates MFI₁ and MFI₃ where 0.8≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.2≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.3≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.4≤2|MFI₁-MFI₃|/(MFI₁+MFI₃)≤2.0;
the first and third polymeric materials of the decorative layer containing striations have respective melt mass flow rates MFI₁ and MFI₃ where MFI₁<MFI₃ and

0.5≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.6≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.7≤2|MFI₁−MFI₃|/(MFI₁+MFI₃)≤2.0;
the first and third polymeric materials of the decorative layer containing striations have respective melt mass flow rates MFI₁ and MFI₃ where MFI₁<MFI₃ and

0.8≤2|MFI₁−MFI₃|/(MFI₁+MFI₃)≤2.0;
the first and third polymeric materials of the decorative layer containing striations have respective melt mass flow rates MFI₁ and MFI₃ where MFI₁>MFI₃ and

0.2≤2|MFI₁−MFI₃|/(MFI₁+MFI₃)≤2.0;
the first and third polymeric materials of the decorative layer containing striations have respective melt mass flow rates MFI₁ and MFI₃ where MFI₁>MFI₃ and

0.3≤2|MFI₁-MFI₃|/(MFI₁+MFI₃)≤2.0;
the first and third polymeric materials of the decorative layer containing striations have respective melt mass flow rates MFI₁ and MFI₃ where MFI₁>MFI₃ and

0.4≤2|MFI₁−MFI₃|/(MFI₁+MFI₃)≤2.0;
the first and third polymeric materials of the decorative layer containing striations have respective melt mass flow rates MFI₁ and MFI₃ where MFI₁>MFI₃ and

0.5≤2|MFI₁-MFI₃|/(MFI₁+MFI₃)≤2.0;
the first and third polymeric materials of the decorative layer containing striations have respective melt mass flow rates MFI₁ and MFI₃ where MFI₁>MFI₃ and

0.6≤2|MFI₁−MFI₃|/(MFI₁+MFI₃)≤2.0;
the first and third polymeric materials of the decorative layer containing striations have respective melt mass flow rates MFI₁ and MFI₃ where MFI₁>MFI₃ and

0.7≤2|MFI₁−MFI₃|/(MFI₁+MFI₃)≤2.0;
the first and third polymeric materials of the decorative layer containing striations have respective melt mass flow rates MFI₁ and MFI₃ where MFI₁>MFI₃ and

0.8≤2|MFI₁−MFI₃|/(MFI₁+MFI₃)≤2.0;
the second and third polymeric materials have respective melt mass flow rates MFI₂ and MFI₃ where 0.3≤2|MFI₂−MFI₃|/(MFI₂+MFI₃)≤2.0;
the second and third polymeric materials have respective melt mass flow rates MFI₂ and MFI₃ where 0.4≤2|MFI₂−MFI₃|/(MFI₂+MFI₃)≤2.0;
the second and third polymeric materials have respective melt mass flow rates MFI₂ and MFI₃ where 0.5≤2 (MFI₂−MFI₃|/(MFI₂+MFI₃)≤2.0;
the second and third polymeric materials have respective melt mass flow rates MFI₂ and MFI₃ where 0.6≤2|MFI₂−MFI₃|/(MFI₂+MFI₃)≤2.0;
the second and third polymeric materials have respective melt mass flow rates MFI₂ and MFI₃ where 0.7≤2|MFI₂−MFI₃|/(MFI₂+MFI₃)≤2.0;
the second and third polymeric materials have respective melt mass flow rates MFI₂ and MFI₃ where 0.8≤2|MFI₂−MFI₃|/(MFI₂+MFI₃)≤2.0;
the second and third polymeric materials have respective melt mass flow rates MFI₂ and MFI₃ where MFI₂<MFI₃ and

0.2≤2|MFI₂−MFI₃|/(MFI₂+MFI₃)≤2.0;
the second and third polymeric materials have respective melt mass flow rates MFI₂ and MFI₃ where MFI₂<MFI₃ and

0.3≤2|MFI₂-MFI₃|/(MFI₂+MFI₃)≤2.0;
the second and third polymeric materials have respective melt mass flow rates MFI₂ and MFI₃ where MFI₂<MFI₃ and

0.4≤2|MFI₂−MFI₃|/(MFI₂+MFI₃)≤2.0;
the second and third polymeric materials have respective melt mass flow rates MFI₂ and MFI₃ where MFI₂<MFI₃ and

0.5≤2|MFI₂−MFI₃|/(MFI₂+MFI₃)≤2.0;
the second and third polymeric materials have respective melt mass flow rates MFI₂ and MFI₃ where MFI₂<MFI₃ and

0.6≤2|MFI₂−MFI₃|/(MFI_{z}+MFI₃)≤2.0;
the second and third polymeric materials have respective melt mass flow rates MFI₂ and MFI₃ where MFI₂<MFI₃ and

0.7≤2|MFI₂−MFI₃|/(MFI₂+MFI₃)2.0;
the second and third polymeric materials have respective melt mass flow rates MFI₂ and MFI₃ where MFI₂<MFI₃ and

0.8≤2|MFI₂−MFI₃|/(MFI₂+MFI₃)≤2.0;
the third polymeric material of the decorative layer containing striations has a melt mass flow rate MFI₁ in the range from 1 to 150 g/10 min;
the third polymeric material of the decorative layer containing striations has a melt mass flow rate MFI₁ in the range from 10 to 150 g/10 min;
the third polymeric material of the decorative layer containing striations has a melt mass flow rate MFI₁ in the range from 20 to 150 g/10 min;
the third polymeric material of the decorative layer containing striations has a melt mass flow rate MFI₁ in the range from 30 to 150 g/10 min;
the third polymeric material of the decorative layer containing striations has a melt mass flow rate MFI₃ in the range from 40 to 150 g/10 min;
the third polymeric material of the decorative layer containing striations has a melt mass flow rate MFI₃ in the range from 50 to 150 g/10 min;
the third polymeric material of the decorative layer containing striations has a melt mass flow rate MFI₃ in the range from 50 to 100 g/10 min;
the first, second and/or third polymeric material of the decorative layer containing striations independently consists, based on its respective total weight, of 60% to 99% by weight of one or more polymers and 1% to 40% by weight of one or more additives;
the first, second and/or third polymeric material of the decorative layer containing striations independently comprises a polyolefin;
the first, second and/or third polymeric material of the decorative layer containing striations independently comprises one or more vinyl chloride polymers;
the first, second and/or third polymeric material of the decorative layer containing striations independently comprises a semicrystalline or amorphous polyester;
the first, second and/or third polymeric material independently comprises polyethylene terephthalate of the APET, PETP or PETG type;
the first, second and/or third polymeric material of the decorative layer containing striations independently comprises a polypropylene;
the first, second and/or third polymeric material of the decorative layer containing striations independently comprises a polystyrene;
the first, second and/or third polymeric material of the decorative layer containing striations independently comprises acrylonitrile-butadiene-styrene (ABS);
the first, second and/or third polymeric material of the decorative layer containing striations independently comprises one or more additives selected from processing auxiliaries, thermal stabilizers, lubricants, polymeric modifiers, foaming agents, matting agents, inorganic fillers, dyes and pigments, fungicides, UV stabilizers, flame retardants and fragrances;
the first, second and/or third polymeric material of the decorative layer containing striations independently comprises one or more inorganic fillers selected from chalk, talc, mica, alumina, kaolin, silicates and titania;
the first, second and/or third polymeric material of the decorative layer containing striations independently comprises one or more lubricants selected from waxes, greases, paraffins, epoxidized soybean oil and polymers based on acrylate esters;
the first, second and/or third polymeric material of the decorative layer containing striations independently comprises one or more polymeric modifiers selected from polymers based on acrylate, butyl-methacrylate, methacrylate-butyl-styrene, methyl methacrylate-butadiene-styrene and chlorinated polyethylene;
the at least one the decorative layer containing striations has a visual texture with a woodlike impression;
the at least one decorative layer containing striations has a visual texture having a luminance in transverse direction of the film, on a scale from 0 to 255, that has a standard deviation of 5 to 50;
the at least one decorative layer containing striations has a visual texture having a luminance in transverse direction of the film, on a scale from 0 to 255, that has a standard deviation of 5 to 30;
the at least one decorative layer containing striations has a visual texture having a luminance in transverse direction of the film, on a scale from 0 to 255, that has a standard deviation of 5 to 20;
the at least one decorative layer containing striations has a visual texture having a luminance in transverse direction of the film, on a scale from 0 to 255, that has a standard deviation of 5 to 15;
the at least one decorative layer containing striations has a visual texture having a luminance in machine direction of the film, on a scale from 0 to 255, that has a standard deviation of 0 to 6;
the at least one decorative layer containing striations has a visual texture having a luminance in transverse and machine direction of the film that has respective standard deviations S_{T} and S_{M}, where the ratio S_{T}/S_{M}≥1.2;
the at least one decorative layer containing striations has a visual texture having a luminance in transverse and machine direction of the film that has respective standard deviations S_{T} and S_{M}, where the ratio S_{T}/S_{M}≥1.5;
the at least one decorative layer containing striations has a visual texture having a luminance in transverse and machine direction of the film that has respective standard deviations S_{T} and S_{M}, where the ratio S_{T}/S_{M}≥2.0;
the at least one decorative layer containing striations has a visual texture with a directionality of ≥20% within an angle range of ±30 degrees about the transverse direction;
the at least one decorative layer containing striations has a visual texture with a directionality of ≥30% or ≥40% within an angle range of ±30 degrees about the transverse direction;
the at least one decorative layer containing striations has a visual texture with a directionality of ≥20%, ≥30% or ≥40% within an angle range of ±25 degrees about the transverse direction;
the at least one decorative layer containing striations has a visual texture with a directionality of ≥20%, ≥30% or ≥40% within an angle range of 20 degrees about the transverse direction;
the at least one decorative layer containing striations has a visual texture with a directionality of ≥20%, ≥30% or ≥40% within an angle range of +15 degrees about the transverse direction;
the at least one decorative layer containing striations has a first surface or interface having an average roughness Rₐ of ≤10 μm, ≤5 μm, 4 μm, 3 μm, ≤2 μm or ≤1 μm;
the at least one decorative layer containing striations has a first surface or interface having a maximum roughness R_{z} of ≥3 μm, ≥5 μm, ≥7 μm, ≥10 μm, ≥15 μm or ≥20 μm;
the at least one decorative layer containing striations has a first surface or interface having a maximum waviness Wₜ of 4 μm, ≥6 μm, 8 μm, ≥12 μm or ≥16 μm;
the at least one decorative layer containing striations has a second surface or interface having an average roughness Rₐ of ≤5 μm,≤4 μm, 3 μm, ≤2 μm or ≤1 μm;
the at least one decorative layer containing striations has a second surface or interface having a maximum roughness R_{z} of ≥3 μm, ≥5 μm, ≥7 μm, 10 μm, ≥15 μm or ≥20 μm; and/or
the at least one decorative layer containing striations has a second surface or interface having a maximum waviness Wₜ of ≥4 μm, ≥6 μm, ≥8 μm, ≥12 μm or ≥16 μm.

A further problem addressed by the invention is that of providing a process for the production of the above-described films. This object is achieved by a process comprising the steps of
(a) providing a first polymeric material having a melt mass flow rate MFI₁;
(b) providing a second polymeric material having a melt mass flow rate MFI₂, where 0.2≤2|MFI₁−MFI₂|/(MFI₁+MFI₂)≤2.0;
(c) feeding the first and second polymeric materials in a volume ratio of 100:0.5 to 100:15 into an extruder or a kneading unit;
(d) plastifying the first and second polymeric materials in the extruder or kneading unit;
(e) forming a mono- or multilayer film, wherein at least one layer, comprising the first and second polymeric materials, of the film is formed by extrusion, coextrusion and/or calendering.

Advantageous embodiments of the process according to the invention are characterized in that
the first and second polymeric materials have respective melt mass flow rates MFI₁ and MFI₂ where 0.3≤2|MFI₁−MFI₂|/(MFI₁+MFI₂)≤2.0;
the first and second polymeric materials have respective melt mass flow rates MFI₁ and MFI₂ where 0.4≤2|MFI₁−MFI₂|/(MFI₁+MFI₂)≤2.0;
the first and second polymeric materials have respective melt mass flow rates MFI₁ and MFI₂ where 0.5≤2|MFI₁−MFI₂|/(MFI₁+MFI₂)≤2.0;
the first and second polymeric materials have respective melt mass flow rates MFI₁ and MFI₂ where 0.6≤2|MFI₁−MFI₂|/(MFI₁+MFI₂)≤2.0;
the first and second polymeric materials have respective melt mass flow rates MFI₁ and MFI₂ where 0.7≤2|MFI₁−MFI₂|/(MFI₁+MFI₂)≤2.0;
the first and second polymeric materials have respective melt mass flow rates MFI₁ and MFI₂ where 0.8≤2|MFI₁−MFI₂|/(MFI₁+MFI₂)≤2.0;
the first and second polymeric materials have respective melt mass flow rates MFI₁ and MFI₂ where MFI₁>MFI₂ and

0.2≤2|MFI₁−MFI₂|/(MFI₁+MFI₂)≤2.0;
the first and second polymeric materials have respective melt mass flow rates MFI₁ and MFI₂ where MFI₁>MFI₂ and

0.3≤2|MFI₁−MFI₂|/(MFI₁+MFI₂)≤2.0;
the first and second polymeric materials have respective melt mass flow rates MFI₁ and MFI₂ where MFI₁>MFI₂ and

0.4≤2|MFI₁-MFI₂|/(MFI₁+MFI₂)≤2.0;
the first and second polymeric materials have respective melt mass flow rates MFI₁ and MFI₂ where MFI₁>MFI₂ and

0.5≤2|MFI₁−MFI₂|/(MFI₁+MFI₂)≤2.0;
the first and second polymeric materials have respective melt mass flow rates MFI₁ and MFI₂ where MFI₁>MFI₂ and

0.6≤2|MFI₁−MFI₂|/(MFI₁+MFI₂)≤2.0;
the first and second polymeric materials have respective melt mass flow rates MFI₁ and MFI₂ where MFI₁>MFI₂ and

0.7≤2|MFI₁−MFI₂|/(MFI₁+MFI₂)≤2.0;
the first and second polymeric materials have respective melt mass flow rates MFI₁ and MFI₂ where MFI₁>MFI₁ and

0.8≤2|MFI₁−MFI₂|/(MFI₁+MFI₂)≤2.0;
the first and second polymeric materials have respective melt mass flow rates MFI₁ and MFI₂ where MFI₁<MFI₂ and

0.2≤2|MFI₁-MFI₂|/(MFI₁+MFI₂)≤2.0;
the first and second polymeric materials have respective melt mass flow rates MFI₁ and MFI₂ where MFI₁<MFI₂ and

0.3≤2|MFI₁−MFI₁/(MFI₁+MFI₂)≤2.0;
the first and second polymeric materials have respective melt mass flow rates MFI₁ and MFI₂ where MFI₁<MFI₂ and

0.4≤2|MFI₁−MFI₂|/(MFI₁+MFI₂)≤2.0;
the first and second polymeric materials have respective melt mass flow rates MFI₁ and MFI₂ where MFI₁<MFI₂ and

0.5≤2|MFI₁−MFI₂|/(MFI₁+MFI₂)≤2.0;
the first and second polymeric materials have respective melt mass flow rates MFI₁ and MFI₂ where MFI₁<MFI₂ and

0.6≤2|MFI₁-MFI₂|/(MFI₁+MFI₂)≤2.0;
the first and second polymeric materials have respective melt mass flow rates MFI₁ and MFI₂ where MFI₁<MFI₂ and

0.7≤2|MFI₁−MFI₂|/(MFI₁+MFI₂)≤2.0;
the first and second polymeric materials have respective melt mass flow rates MFI₁ and MFI₂ where MFI₁<MFI₂ and

0.8≤2|MFI₁−MFI₂|/(MFI₁+MFI₂)≤2.0;
the first polymeric material has a melt mass flow rate MFI₁ in the range from 1 to 150 g/10 min;
the first polymeric material has a melt mass flow rate MFI₁ in the range from 10 to 150 g/10 min;
the first polymeric material has a melt mass flow rate MFI₁ in the range from 20 to 150 g/10 min;
the first polymeric material has a melt mass flow rate MFI₁ in the range from 30 to 150 g/10 min;
the first polymeric material has a melt mass flow rate MFI₁ in the range from 40 to 150 g/10 min;
the first polymeric material has a melt mass flow rate MFI₁ in the range from 50 to 150 g/10 min;
the first polymeric material has a melt mass flow rate MFI₁ in the range from 50 to 100 g/10 min;
the second polymeric material has a melt mass flow rate MFI₂ in the range from 1 to 150 g/10 min;
the second polymeric material has a melt mass flow rate MFI₂ in the range from 1 to 100 g/10 min;
the second polymeric material has a melt mass flow rate MFI₂ in the range from 1 to 50 g/10 min;
the second polymeric material has a melt mass flow rate MFI₂ in the range from 1 to 40 g/10 min;
the second polymeric material has a melt mass flow rate MFI₂ in the range from 1 to 30 g/10 min;
the second polymeric material has a melt mass flow rate MFI₂ in the range from 1 to 20 g/10 min;
the second polymeric material has a melt mass flow rate MFI₂ in the range from 1 to g/10 min;
the second polymeric material has a melt mass flow rate MFI in the range from 4 to 8 g/10 min;
in step (c) the first and second polymeric materials are fed to the extruder or kneading unit in a volume ratio of 100:0.5 to 100:10, 100:0.5 to 100:8, 100:0.5 to 100:6 or 100:0.5 to 100:4;
a third polymeric material having melt mass flow rate MFI₃ is provided and in step (c) is fed to the extruder or kneading unit in a volume ratio of 100:0.5 to 100:15, based on the first polymeric material, where 0.2≤2|MFI₁−MFI₃|/(MFI₁+MFI₃)≤2.0;
in step (c) the third polymeric material is fed to the extruder or kneading unit in a volume ratio of 100:0.5 to 100:10, 100:0.5 to 100:8, 100:0.5 to 100:6 oder 100:0.5 to 100:4, based on the first polymeric material;
the first, second and/or third polymeric material each comprises two or more constituents or components, and two or more constituents or components of the first, second and/or third polymeric material are provided in a separate reservoir vessel and fed to the extruder or kneading unit from the respective reservoir vessel;
one or more further extruders or kneading units are supplied with further polymeric materials, the further polymeric materials are plastifled in the respective extruder or kneading unit and coextruded in step (e) with the layer comprising the first and second polymeric materials in such a way as to form a bi- or multilayer film;
the first and third polymeric materials have respective melt mass flow rates MFI₁ and MFI₃ where 0.3≤2|MFI₁−MFI₃|/(MFI₁+MFI₃)≤2.0;
the first and third polymeric materials have respective melt mass flow rates MFI₁ and MFI₃ where 0.4≤2|MFI₁−MFI₃|/(MFI₁+MFI₃)≤2.0;
the first and third polymeric materials have respective melt mass flow rates MFI₁ and MFI₃ where 0.5≤2|MFI₁−MFI₃|/(MFI₁+MFI₃)≤2.0;
the first and third polymeric materials have respective melt mass flow rates MFI₁ and MFI₃ where 0.6≤2|MFI₁-MFI₃|/(MFI₁+MFI₃)≤2.0;
the first and third polymeric materials have respective melt mass flow rates MFI₁ and MFI₃ where 0.7≤2|MFI₁−MFI₃|/(MFI₁+MFI₃)≤2.0;
the first and third polymeric materials have respective melt mass flow rates MFI₁ and MFI₃ where 0.8≤2|MFI₁−MFI₃|/(MFI₁+MFI₃)≤2.0;
the first and third polymeric materials have respective melt mass flow rates MFI₁ and MFI₃ where MFI₁<MFI₃ and

0.2≤2|MFI₁-MFI₃|/(MFI₁+MFI₃)≤2.0;
the first and third polymeric materials have respective melt mass flow rates MFI₁ and MFI₃ where MFI₁<MFI₃ and

0.3≤2|MFI₁−MFI₃|/(MFI₁+MFI₃)≤2.0;
the first and third polymeric materials have respective melt mass flow rates MFI₁ and MFI₃ where MFI₁<MFI₃ and

0.4≤2|MFI₁−MFI₃|/(MFI₁+MFI₃)≤2.0;
the first and third polymeric materials have respective melt mass flow rates MFI₁ and MFI₃ where MFI₁<MFI₃ and

0.5≤2|MFI₁-MFI₃|/(MFI₁+MFI₃)≤2.0;
the first and third polymeric materials have respective melt mass flow rates MFI₁ and MFI₃ where MFI₁<MFI₃ and

0.6≤2|MFI₁−MFI₃|/(MFI₁+MFI₃)≤2.0;
the first and third polymeric materials have respective melt mass flow rates MFI₁ and MFI₃ where MFI₁<MFI₃ and

0.7≤2|MFI₁−MFI₃|/(MFI₁+MFI₃)≤2.0;
the first and third polymeric materials have respective melt mass flow rates MFI₁ and MFI₃ where MFI₁<MFI₃ and

0.8≤2|MFI₁−MFI₃|/(MFI₁+MFI₃)≤2.0;
the first and third polymeric materials have respective melt mass flow rates MFI₁ and MFI₃ where MFI₁>MFI₃ and

0.2≤2|MFI₁−MFI₃|/(MFI₁+MFI₃)≤2.0;
the first and third polymeric materials have respective melt mass flow rates MFI₁ and MFI₃ where MFI₁>MFI₃ and

0.3≤2|MFI₁−MFI₃|/(MFI₁+MFI₃)≤2.0;
the first and third polymeric materials have respective melt mass flow rates MFI₁ and MFI₃ where MFI₁>MFI₃ and

0.4≤2|MFI₁−MFI₃|/(MFI₁+MFI₃)≤2.0;
the first and third polymeric materials have respective melt mass flow rates MFI₁ and MFI₃ where MFI₁>MFI₃ and

0.5≤2|MFI₁−MFI₃|/(MFI₁+MFI₃)≤2.0;
the first and third polymeric materials have respective melt mass flow rates MFI₁ and MFI₃ where MFI₁>MFI₃ and

0.6≤2|MFI₁−MFI₃|/(MFI₁+MFI₃)≤2.0;
the first and third polymeric materials have respective melt mass flow rates MFI₁ and MFI₃ where MFI₁>MFI₃ and 0.7≤2|MFI₁−MFI₃|/(MFI₁+MFI₃)≤2.0;
the first and third polymeric materials have respective melt mass flow rates MFI₁ and MFI₃ where MFI₁>MFI₃ and

0.8≤2|MFI₁−MFI₃|/(MFI₁+MFI₃)≤2.0;
the second and third polymeric materials have respective melt mass flow rates MFI₂ and MFI₃ where 0.3≤2|MFI₂−MFI₃|/(MFI₂+MFI₃)≤2.0;
the second and third polymeric materials have respective melt mass flow rates MFI₂ and MFI₃ where 0.4≤2|MFI₂−MFI₃|/(MFI₂+MFI₃)≤2.0;
the second and third polymeric materials have respective melt mass flow rates MFI₂ and MFI₃ where 0.5≤2|MFI₂−MFI₃|/(MFI₂+MFI₃)≤2.0;
the second and third polymeric materials have respective melt mass flow rates MFI₂ and MFI₃ where 0.6≤2|MFI₂−MFI₃|/(MFI₂+MFI₃)≤2.0;
the second and third polymeric materials have respective melt mass flow rates MFI₂ and MFI₃ where 0.7≤2|MFI₂−MFI₃|/(MFI₂+MFI₃)≤2.0;
the second and third polymeric materials have respective melt mass flow rates MFI₂ and MFI₃ where 0.8≤2|MFI₂−MFI₃|/(MFI₂+MFI₃)≤2.0;
the second and third polymeric materials have respective melt mass flow rates MFI₂ and MFI₃ where MFI₂<MFI₃ and

0.2≤2|MFI₂−MFI₃|/(MFI₂+MFI₃)≤2.0;
the second and third polymeric materials have respective melt mass flow rates MFI₂ and MFI₃ where MFI₂<MFI₃ and

0.3≤2|MFI₂−MFI₁|/(MFI₂+MFI₃)≤2.0;
the second and third polymeric materials have respective melt mass flow rates MFI₂ and MFI₃ where MFI₂<MFI₃ and

0.4≤2|MFI₂−MFI₃|/(MFI₂+MFI₃)≤2.0;
the second and third polymeric materials have respective melt mass flow rates MFI₂ and MFI₃ where MFI₂<MFI₃ and

0.5≤2|MFI₂−MFI₃|/(MFI₂+MFI₃)≤2.0;
the second and third polymeric materials have respective melt mass flow rates MFI₂ and MFI₃ where MFI₂<MFI₃ and

0.6≤2|MFI₂−MFI₃|/(MFI₂+MFI₃)≤2.0;
the second and third polymeric materials have respective melt mass flow rates MFI₂ and MFI₃ where MFI₂<MFI₃ and

0.7≤2|MFI₂−MFI₃|/(MFI₂+MFI₃)≤2.0;
the second and third polymeric materials have respective melt mass flow rates MFI₂ and MFI₃ where MFI₂<MFI₃ and

0.8≤2|MFI₂−MFI₃|/(MFI₂+MFI₃)≤2.0;
the third polymeric material has a melt mass flow rate MFI₃ in the range from 1 to 150 g/10 min;
the third polymeric material has a melt mass flow rate MFI₃ in the range from 10 to 150 g/10 min;
the third polymeric material has a melt mass flow rate MFI₃ in the range from 20 to 150 g/10 min;
the third polymeric material has a melt mass flow rate MFI₃ in the range from 30 to 150 g/10 min;
the third polymeric material has a melt mass flow rate MFI₃ in the range from 40 to 150 g/10 min;
the third polymeric material has a melt mass flow rate MFI₃ in the range from 50 to 150 g/10 min;
the third polymeric material has a melt mass flow rate MFI₃ in the range from 50 to 100 g/10 min;
the first polymer material is transparent;
the second polymer material is transparent;
the second polymeric material comprises one or more dyes or colour pigments;
the second polymeric material comprises a brown dye or brown colour pigments;
the second polymeric material comprises a white dye or white colour pigments;
the second polymeric material comprises particles of a mineral material, for example mica;
the second polymeric material comprises particles of a metallic material, for example aluminium;
the first polymeric material comprises one or more dyes or colour pigments;
the first polymeric material comprises a brown dye or brown colour pigments;
the first polymeric material comprises a white dye or white colour pigments;
the first polymeric material comprises particles of a mineral material, for example mica;
the first polymeric material comprises particles of a metallic material, for example aluminium;
the first polymeric material is transparent and the second polymeric material comprises one or more dyes or colour pigments;
the second polymeric material is transparent and the first polymeric material comprises one or more dyes or colour pigments;
the first and second polymeric materials each comprise one or more dyes or colour pigments, where the dyes or colour pigments of the first and second polymeric materials have different colours and/or are present in different concentrations in the first and second polymeric materials;
the first and second polymeric materials are transparent and the first polymeric material comprises transparent pigments having a refractive index different from the first polymeric material;
the first and second polymeric materials are transparent and the second polymeric material comprises transparent pigments having a refractive index different from the first polymeric material;
the third polymeric material comprises one or more dyes or colour pigments;
the third polymeric material comprises a brown dye or brown colour pigments;
the third polymeric material comprises a white dye or white colour pigments;
the third polymeric material comprises particles of a mineral material, for example mica;
the third polymeric material comprises particles of a metallic material, for example aluminium;
the film comprises one or more core layers, interlayers or outer layers of one or more polymeric materials which independently consist, based on their respective total weights, of 60% to 99% by weight of one or more polymers and 1% to 40% by weight of one or more additives;
the film comprises one or more core layers, interlayers or outer layers of one or more polymeric materials which independently consist, based on their respective total weights, of 60% to 99% by weight of one or more polymers and 1% to 40% by weight of one or more additives, where the additives are selected from processing auxiliaries, thermal stabilizers, lubricants, polymeric modifiers, foaming agents, matting agents, inorganic fillers, dyes and pigments, fungicides, UV stabilizers, flame retardants and fragrances;
the first, second and/or third polymeric material independently consists, based on its respective total weight, of 60% to 99% by weight of one or more polymers and 1% to 40% by weight of one or more additives;
the first, second and/or third polymeric material independently comprises a polyolefin;
the first, second and/or third polymeric material independently comprises one or more vinyl chloride polymers;
the first, second and/or third polymeric material independently comprises a semicrystalline or amorphous polyester;
the first, second and/or third polymeric material independently comprises polyethylene terephthalate of the APET, PETP or PETG type;
the first, second and/or third polymeric material independently comprises polypropylene;
the first, second and/or third polymeric material independently comprises polystyrene;
the first, second and/or third polymeric material independently comprises acrylonitrile-butadiene-styrene (ABS);
the first, second and/or third polymeric material independently comprises one or more additives selected from processing auxiliaries, thermal stabilizers, lubricants, polymeric modifiers, foaming agents, matting agents, inorganic fillers, dyes and pigments, fungicides, UV stabilizers, flame retardants and fragrances;
the first, second and/or third polymeric material independently comprises one or more inorganic fillers selected from chalk, talc, mica, alumina, kaolin, silicates and titania;
the first, second and/or third polymeric material independently comprises one or more lubricants selected from waxes, greases, paraffins, epoxidized soybean oil and polymers based on acrylate esters; and/or
the first, second and/or third polymeric material independently comprises one or more polymeric modifiers selected from polymers based on acrylate, butyl-methacrylate, methacrylate-butyl-styrene, methyl methacrylate-butadiene-styrene and chlorinated polyethylene.

The invention further relates to a mono- or multilayer film produced by one of the above-described processes.

The invention further relates to articles, for example trays, cups and blister packaging, produced from one of the above-described films by thermoforming.

In the case of mono- and multilayer films, the homogeneity of the one or more layers is an important quality criterion. Even slight visual variations in structure, colour or other aspects in a film layer are undesirable and lead to classification of the film in question as reject material on quality control. Accordingly, various measures are taken in industrial film manufacturing to obtain films having very substantially homogeneous structural and visual properties. Examples of these measures include:
matching of the rheological properties of the polymeric materials in order to assure good mixing of the materials in an extruder or kneading unit used for the plastification;
mechanical filtering of the plastified materials in order to retain gel particles having elevated viscosity; and
precise metering of dyes by means of an electronic closed-loop control circuit in conjunction with a colour spectrometer.

The inventors of the present invention have found that, surprisingly, it is possible through the use of two or more polymeric materials having poor or zero miscibility to produce a film or film layer having a visually attractive texture. In this case, the miscibility of the polymeric materials and the inhomogeneity of the film or film layer produced therefrom must be considerably poorer or less marked compared to the material combinations used in established film manufacture and the low variance in the physical product properties achieved thereby. In order to obtain the texture effects according to the invention, marked mixture incompatibility or a miscibility gap in the polymeric materials used is required, which entails control of the rheological properties.

In the present invention, the term “first polymeric material”, “second polymeric material” and “third polymeric material” in each case refers to a polymeric material which comprises one or more polymers and one or more additives and which forms an essentially homogeneous mixture or homogeneous phase on plastification in an extruder or in a kneading unit. It is appropriate here, but not absolutely obligatory, for the individual constituents or components of the first, second and third polymeric material to be mixed with one another before they are introduced into an extruder or kneading unit used for the plastification. Instead, the constituents or components of the first, second and/or third polymeric material may be metered into the extruder or kneading unit from two or more than two separate reservoir vessels (hoppers). In order that the first, second and third polymeric material forms a homogeneous mixture or phase in each case on plastification in an extruder or kneading unit, the plastifiable constituents and especially the polymeric components of the first, second and third polymeric material must each have similar rheological properties or a comparable melt mass flow rate. It is unimportant here whether the constituents of the first, second and third polymeric material are in commixed form before they are metered into an extruder or kneading unit or are fed in from separate reservoir vessels (hoppers).

In the present invention, the term “machine direction” or “longitudinal direction” refers to the transport or winding direction of the extruder or calendar used for the manufacture of the film. Accordingly, the term “transverse direction” refers to a direction at right angles to machine direction.

In the present invention, the term “volume ratio of the striations to the matrix” refers to a volume ratio V₂/V₁ calculated using the mass ratio M₂/M₁ of the second polymeric material, based on the first polymeric material. The calculation of the volume ratio V₂/V₁ takes account of the respective densities ρ₁ and ρ₂ of the first and second polymeric materials according to the relationship

$$\frac{{V}_{2}}{{V}_{1}} = \frac{{M}_{2}}{{M}_{1}} \cdot \frac{{ρ}_{1}}{{ρ}_{2}} \qquad ( I )$$

The film according to the invention and the at least one decorative layer containing striations consist of materials comprising one or more polymers preferably selected from vinyl chloride polymers, semicrystalline or amorphous polyesters, polyolefins, polypropylene, polystyrene and acrylonitrile-butadiene-styrene (ABS).

In the present invention, the term “vinyl chloride polymer” refers to vinyl chloride homopolymers, vinyl chloride copolymers and mixtures of the above polymers. More particularly, the term “vinyl chloride polymer” encompasses
polyvinyl chloride (PVC) produced by homopolymerization of vinyl chloride, and
vinyl chloride copolymers that are formed by polymerization of vinyl chloride with one or more comonomers such as ethylene, propylene or vinyl acetate.

Semicrystalline or amorphous polyester used is preferably PETP, APET, glycol-modified polyethylene terephthalate (PETG) or acid-modified polyethylene terephthalate. A polyester of the PETP type is supplied, for example, by Indorama Corp. under the RAMAPET® N180 product name. A polyester of the APET type is sold, for example, by Invista S.à r.l. under the POLYCLEAR® 1101 product name. In amorphous glycol-modified polyethylene terephthalate (PETG), glycol units have preferably been replaced by cyclohexane-1,4-dimethanol units. Such a cyclohexane-1,4-dimethanol-modified polyethylene terephthalate is supplied commercially by Eastman Chemical Company (Tennessee, USA) under the EASTAR COPOLYESTER® 6763 product name.

In another appropriate embodiment of the invention, a semicrystalline or amorphous polyester having a crystallization half-life of at least 5 minutes is used. A copolyester of this kind is described, for example, in patent EP 1 066 339 BI to the Eastman Chemical Company. This copolyester has been formed from (i) diacid radical components and (ii) diol radical components. The diacid radical components (i) comprise at least 80 mol % of a diacid radical component selected from terephthalic acid, naphthalenedicarboxylic acid, cyclohexane-1,4-dicarboxylic acid, isophthalic acid and mixtures thereof, based on all diacid radical components present in the copolyester (=100 mol %). The diol radical components (ii) comprise 80 to 100 mol % of a diol radical component selected from diols having 2 to 10 carbon atoms and mixtures thereof and 0 to 20 mol % of a modifying diol selected from propane-1,3-diol, butane-1,4-diol, pentane-1,5-diol, hexane-1,6-diol, octane-1,8-diol, 2,2,4-trimethylpentane-1,3-diol, propylene glycol, 2,2,4,4-tetramethylcyclobutane-1,3-diol, based on all diol radicals present in the copolyester (=100 mol %). Amorphous or semicrystalline copolyesters having a crystallization half-life of at least 5 minutes are of good suitability for conventional calendering methods. With a polymeric material containing a significant proportion—generally more than 50% by weight—of semicrystalline or amorphous copolyester having a crystallization half-life of at least 5 minutes, it is possible by calendering to produce homogeneous and virtually defect-free films.

Amorphous or semicrystalline polyesters having a crystallization half-life of at least 5 minutes are supplied commercially, inter alia, by Eastman Chemical Company under the CADENCE COPOLYESTER® product name. These copolyesters are used as the main component for the manufacture of polyester films, where the proportion thereof in the total weight of the polyester film is generally more than 40% to 70% by weight.

The crystallization half-life of the copolyesters used for the film is determined with the aid of a dynamic differential calorimeter (differential scanning calorimetry or DSC). Dynamic differential calorimetry (DSC) is a standard method for the measurement of the thermal properties, especially the phase transition temperatures, of solid-state materials. In the present invention, the crystallization half-life is determined by heating 15 mg of the copolyester to be analysed to 290° C., then cooling it in the presence of helium at a rate of 320° C. per minute to a defined temperature of 180 to 210° C. and detecting the period of time until attainment of the isothermal crystallization temperature or the crystallization peak of the DSC curve. The crystallization half-life is determined from the time-dependent crystallization profile. The crystallization half-life corresponds to the time which is required at the defined temperature of 180 to 210° C. after the initial phase of the crystallization to obtain 50% of the maximum achievable crystallinity in the sample.

In the present invention, the term “film” refers to individualized pieces of a film having dimensions of 0.1 to 1 m and industrially manufactured film sheets having lengths of several hundred to several thousand metres.

The visual texture or the pattern of the at least one decorative layer containing striations in the films according to the invention is immediately apparent to the human eye and instantly catches the eye of an observer. In qualitative terms, the visual texture can be described as a multitude of striations in the form of stripes running parallel to machine direction with irregularly varying width and blurred edges. A vast majority of the observers assess the visual texture as woodlike decoration.

Regardless of their good visual perceptibility, owing to flowing colour transitions and the random variation in stripe width with machine direction, no exact mathematical description of the visual texture is possible. Therefore, the visual texture of the films according to the invention is described additionally by means of statistical methods. For this purpose, firstly, the scatter or standard deviation of the luminance or brightness in transverse and machine direction and, secondly, the directionality or statistical distribution of the luminance or grey value gradients of the visual texture are determined. The methods used for the characterization of the visual texture are described in detail in a section that follows.

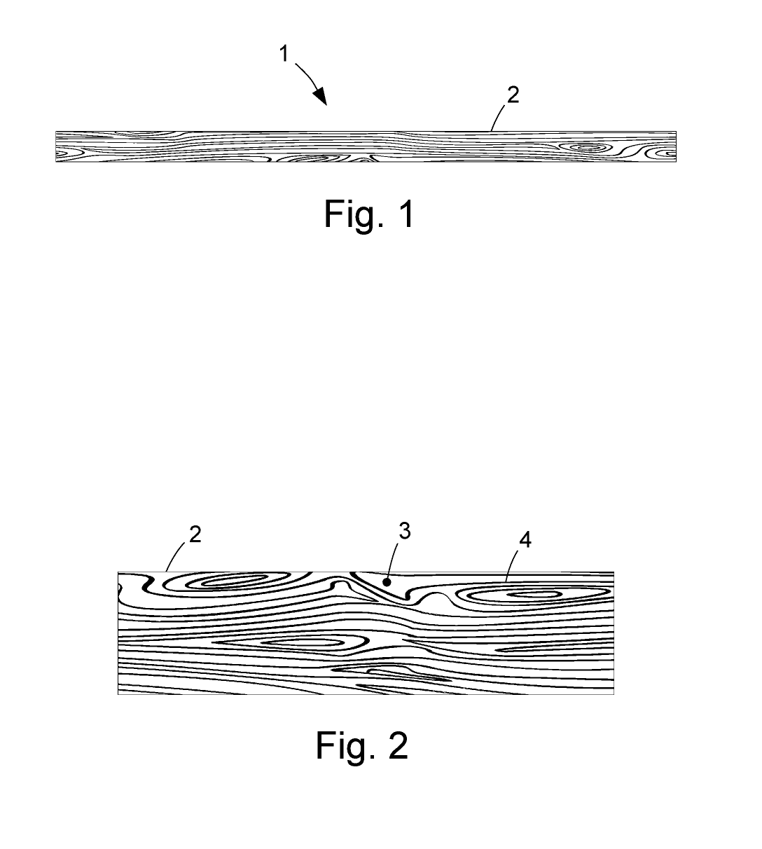

FIG. 1 shows a schematic sectional view of a monolayer film 1 according to the invention with a decorative layer 2 containing striations.

FIG. 2 shows a schematic detailed view of the decorative layer 2 containing striations and having a matrix 3 of a first polymeric material and striations 4 of a second polymeric material embedded into the matrix 3.

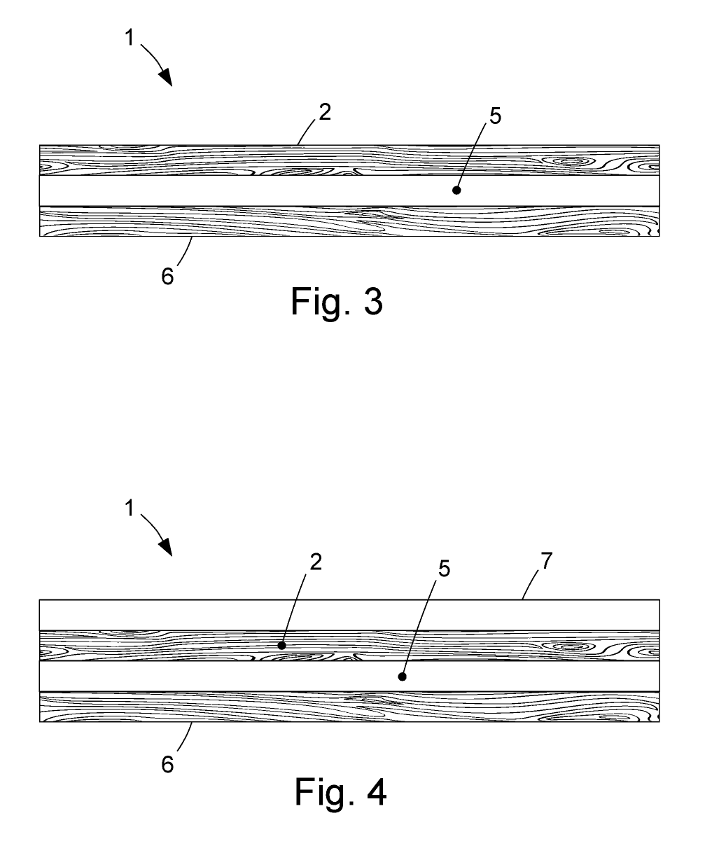

FIG. 3 shows a schematic sectional view of a trilayer film 1 according to the invention with a carrier layer 5 and first and second decorative layers 2 and 6 containing striations. The carrier layer 5 is arranged between the first and second decorative layers 2 and 6 containing striations. The first and second decorative layers 2 and 6 containing striations each form an outer face of the film 1 and are thus visible.

In an advantageous embodiment, the polymeric materials of which the first and second decorative layers 2 and 6 containing striations consist are different from one another. More particularly, the dyes or colour pigments present in the decorative layers 2 and 6 differ from one another.

In a further appropriate embodiment, some or all polymeric materials of which the first and second decorative layers 2 and 6 containing striations consist are the same.

In a preferred embodiment, the core layer 5 is opaque. More particularly, the core layer 5 is coloured.

FIG. 4 shows a schematic sectional view of a tetralayer film 1 according to the invention with a carrier layer 5, first and second decorative layers 2 and 6 containing striations, and a transparent outer layer 7. In an advantageous embodiment of the process according to the invention, the core layer 5, the decorative layers 2 and 6, and the transparent outer layer 7 are coextruded. In an alternative, likewise advantageous embodiment of the process according to the invention, the core layer 5 and the decorative layers 2 and 6 are coextruded, and the transparent outer layer 7 is subsequently laminated onto the decorative layer 2.

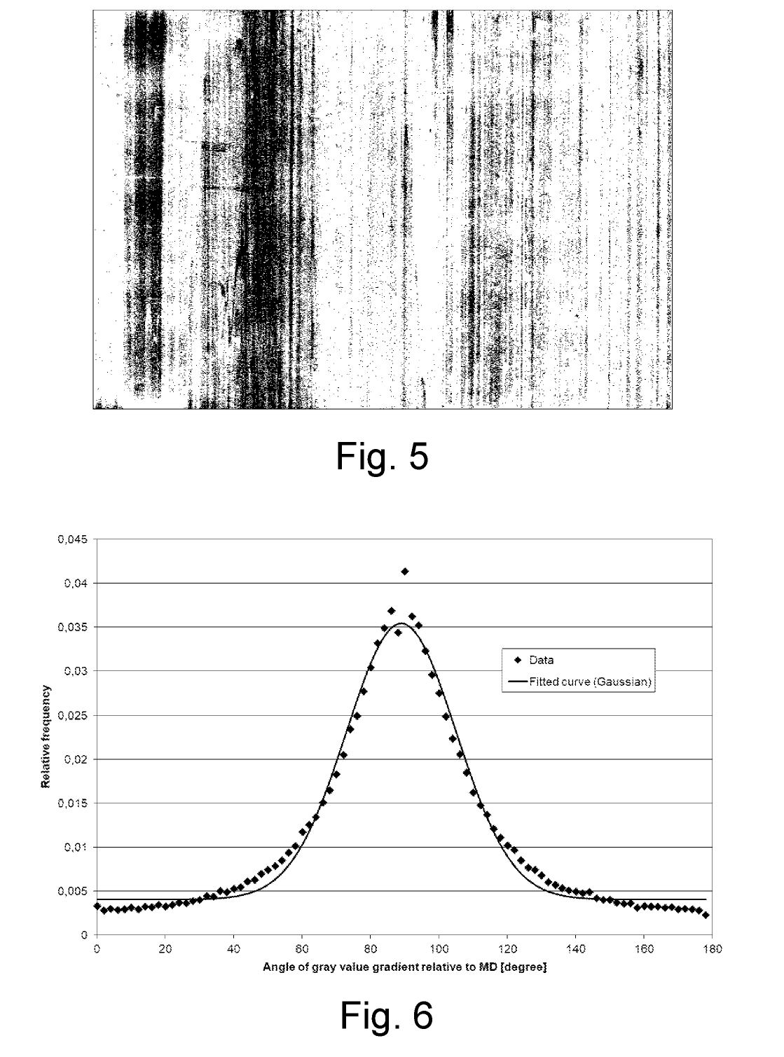

FIG. 5 shows a first example of a texture of a film according to the invention (Example 2B) having striations in the form of stripes, the longitudinal axis of which is aligned essentially parallel to a machine direction MD of the film. In the plane of the drawing of FIG. 5, machine direction MD runs from the bottom upward (or from the top downward).

FIG. 6 shows a diagram with directionality data of the texture shown in FIG. 5. The horizontal abscissa axis of the diagram shows the angle, based on machine direction MD, of the grey value gradient in increments or intervals having a width of 2 degrees. The vertical ordinate axis indicates the frequency of the respective grey value gradient angle within an interval. It is immediately clear from the diagram of FIG. 6 that a considerable proportion of the pixels have a grey value gradient oriented essentially at right angles to machine direction MD, i.e. in transverse direction TD.

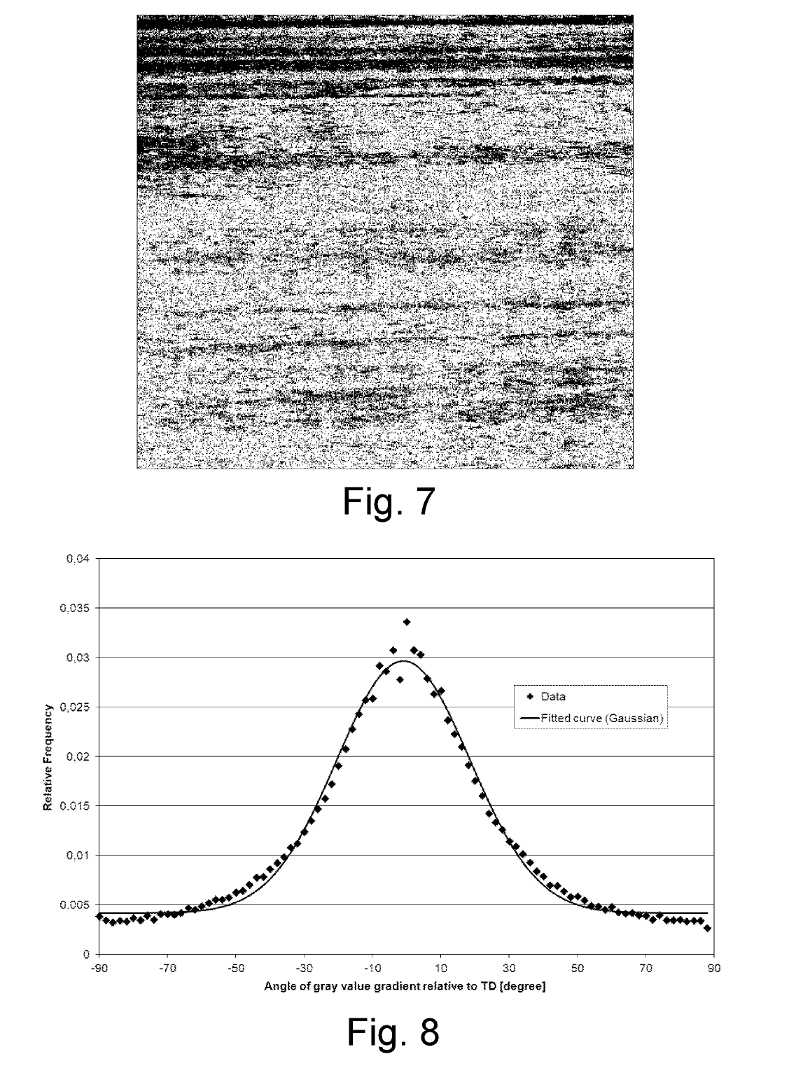

FIG. 7 shows a second example of a texture of a film according to the invention (Example 3A) having striations in the form of stripes, the longitudinal axis of which is aligned essentially parallel to a machine direction MD of the film. In the plane of the drawing of FIG. 7, machine direction MD runs from left to right (or from right to left).

FIG. 8 shows a diagram with directionality data of the texture shown in FIG. 7. The horizontal abscissa axis of the diagram shows the angle, based on transverse direction TD, of the grey value gradient in increments or intervals having a width of 2 degrees. The vertical ordinate axis indicates the frequency of the respective grey value gradient angle within an interval. It is immediately clear from the diagram of FIG. 8 that a considerable proportion of the pixels have a grey value gradient oriented essentially in transverse direction TD.

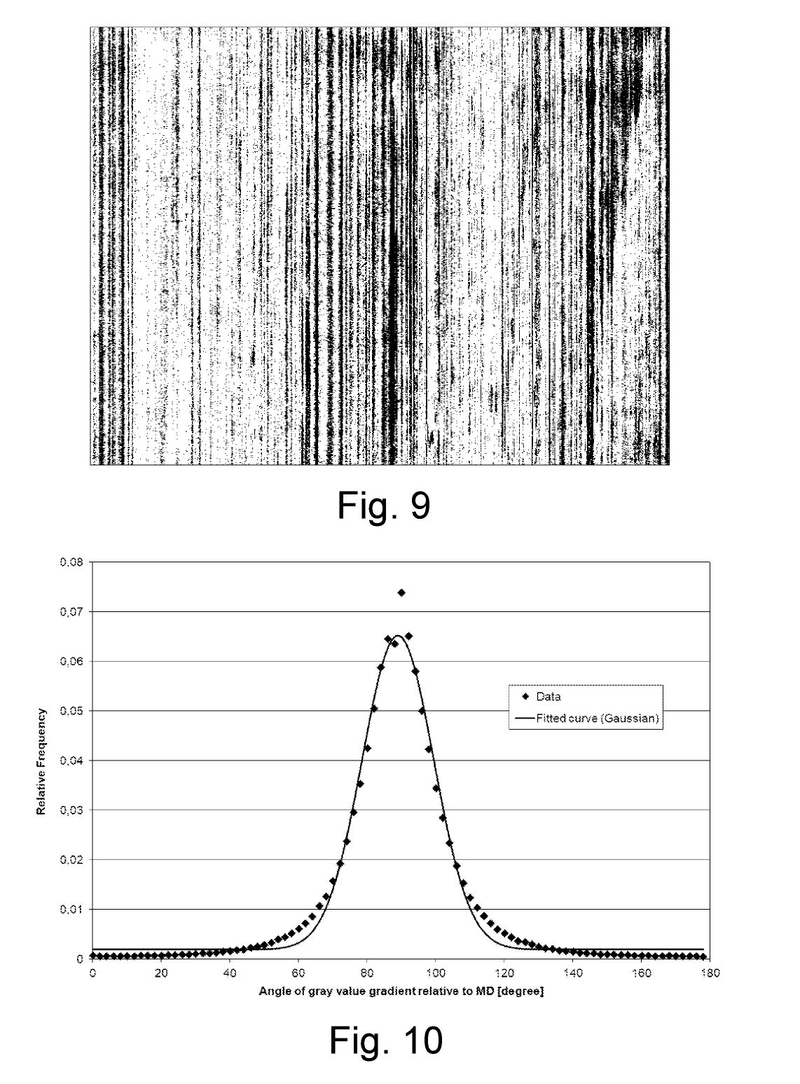

FIG. 9 shows a third example of a texture of a film according to the invention (Example 4A) having striations in the form of stripes, the longitudinal axis of which is aligned essentially parallel to a machine direction MD of the film. In the plane of the drawing of FIG. 9, machine direction MD runs from the bottom upward (or from the top downward).

FIG. 10 shows a diagram with directionality data of the texture shown in FIG. 9. The horizontal abscissa axis of the diagram shows the angle, based on machine direction MD, of the grey value gradient in increments or intervals having a width of 2 degrees. The vertical ordinate axis indicates the frequency of the respective grey value gradient angle within an interval. It is immediately clear from the diagram of FIG. 10 that a considerable proportion of the pixels have a grey value gradient oriented essentially at right angles to machine direction MD, i.e. in transverse direction TD.

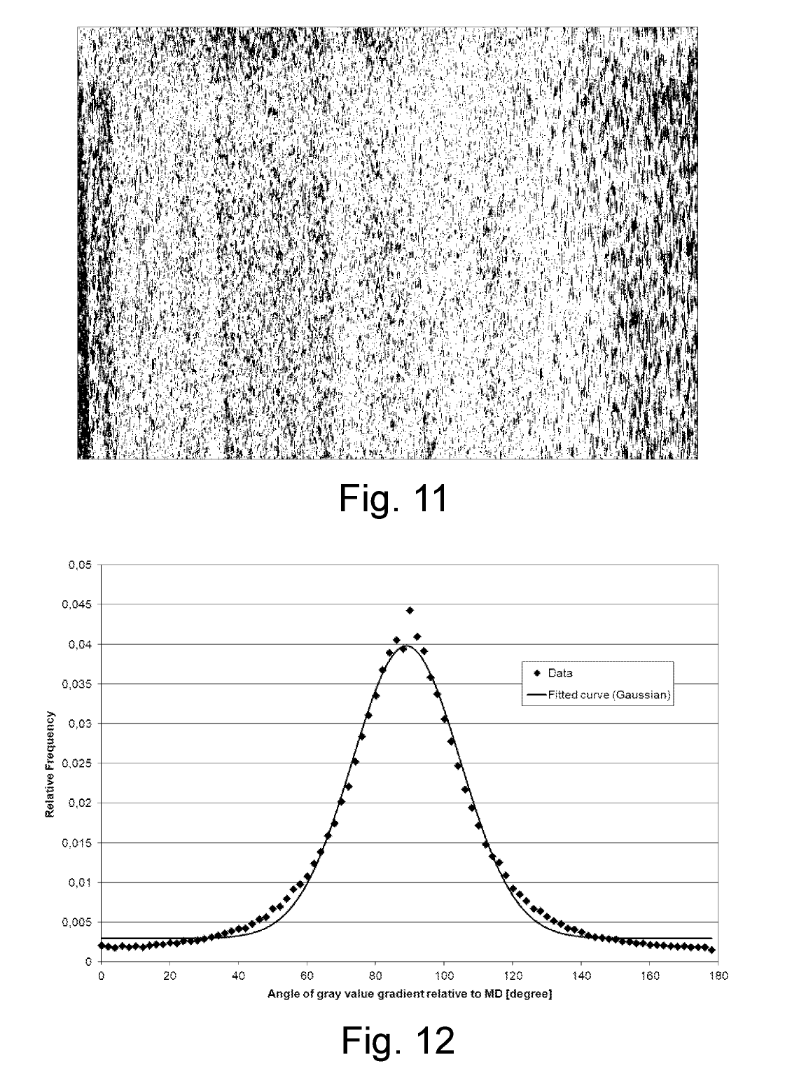

FIG. 11 shows a fourth example of a texture of a film according to the invention (Example 4B) having striations in the form of stripes, the longitudinal axis of which is aligned essentially parallel to a machine direction MD of the film. In the plane of the drawing of FIG. 11, machine direction MD runs from the bottom upward (or from the top downward).

FIG. 12 shows a diagram with directionality data of the texture shown in FIG. 11. The horizontal abscissa axis of the diagram shows the angle, based on machine direction MD, of the grey value gradient in increments or intervals having a width of 2 degrees. The vertical ordinate axis indicates the frequency of the respective grey value gradient angle within an interval. It is immediately clear from the diagram of FIG. 12 that a considerable proportion of the pixels have a grey value gradient oriented essentially at right angles to machine direction MD, i.e. in transverse direction TD.

Each of the diagrams of FIGS. 6, 8, 10 and 12 additionally shows a normal distribution or Gaussian curve fitted by means of nonlinear regression to the frequency distribution of the grey value gradient angle, which is also referred to in the legend of the diagram as “fitted curve”. It is immediately apparent that the fitted Gaussian curve gives a good approximation of the frequency distribution of the grey value gradient angle. The production process according to the invention is subject to stochastic variations that are manifested in the Gaussian frequency distribution of the grey value gradient angle.

### Examples

By means of a coextrusion system with three extruders, five films, each of them trilayered, are produced by the process according to the invention. Each of the five films comprises a core layer and two decorative layers containing striations, with the core layer arranged between the two decorative layers. The two decorative layers of a film are each different from one another. Accordingly, the inventive examples, with reference to the decorative layers, are referred to by the numbers 1A, 1B, 2A, 2B, 3A, 3B, 4A, 4B, 5A and 5B.

The base polymer used for the core layer was a conventional polyester of the PETP INDORAMA® N180 type with an intrinsic viscosity 0.8 dl/g (0.8 decilitre/g), corresponding to a melt mass flow rate: MFI≈30 g/10 min. The polymeric material for the two decorative layers consists essentially of PETP and a matting additive based on CaCO₃. Both the core layer and each of the decorative layers additionally comprise one or two commercial colour masterbatches based on polyethylene. Commercially supplied colour masterbatches have melt mass flow rates that vary within a wide range from 1 to 150 g/10 min according to the type and degree of polymerization or average molecular weight of the base polymer (polyethylene in the present case). The composition of the materials used for the production of the inventive film examples is shown in Table 1.

TABLE 1
Film examples

| | | Example No. | | | | | | | | | |
|---|---|---|---|---|---|---|---|---|---|---|---|
| | | 1A | 1B | 2A | 2B | 3A | 3B | 4A | 4B | 5A | 5B |
| Texture code | | 84RT006-1 | | 84RT006-2 | | 84RT009 | | 84R1010 | | 84RT011 | |
| Total thickness | | 436 μm | | 286 μm | | 395 μm | | 346 mm | | 800 μm | |
| Layer structure | | A/B/C | | A/B/C | | A/B/C | | A/B/C | | A/B/C | |
| and thickness | | 4/92/4% | | 6/88/6% | | 4/92/4% | | 4/92/4% | | 2.5/95/2.5% | |
| | MEI | Parts | | Parts | | Parts | | Parts | | Parts | |
| Core layer B | [g/10 min] | [% by wt.] | | [% by wt.] | | [% by wt.] | | [% by wt.] | | [% by wt.] | |
| PETP | 31 | 98 | | 97.2 | | 98 | | 98 | | 96.2 | |
| Colour MB I | 45 | 2 | | 2.0 | | 2 | | 2 | | — | |
| Colour MB II | 35 | — | | — | | — | | — | | 2.6 | |
| Foaming MB* | — | — | | 08 | | — | | — | | 1.2 | |
| Decorative layer** | | A | C | A | C | A | C | A | C | A | C |
| PETP | 31 | 49.0 | 49.0 | 49.0 | 49.0 | 49.0 | 49.0 | 49.0 | 49.0 | 53.0 | 94.0 |
| Matting MB*** | 30 | 49.0 | 49.0 | 49.0 | 49.5 | 49.5 | 49.5 | 48.5 | 48.5 | 45.0 | — |
| PETP + CaCO₃ | | | | | | | | | | | |
| Colour MB 1 | 100 | — | — | — | — | 0.75 | 0.75 | 1.25 | 1.25 | — | — |
| Colour MB 2 | 5 | — | — | — | — | 0.75 | 0.75 | 1.25 | 1.25 | — | — |
| Colour MB 3 | 54 | 0.8 | 0.8 | 0.8 | — | — | — | — | — | 0.8 | — |
| Colour MB 4 | 6 | 1.2 | 1.2 | 1.2 | — | — | — | — | — | 1.2 | — |
| Colour MB 5 | 75 | — | — | — | 1.5 | — | — | — | — | — | — |
| Colour MB 6 | 85 | — | — | — | — | — | — | — | — | — | 2.5 |
| Brightener MB | 30 | — | — | — | — | — | — | — | — | — | 3.5 |

MB ≡ masterbatch
*Foaming masterbatch based on citric acid
**Decorative layers A and C produced with different extrusion parameters
***Matting masterbatch composed of 70% to 75% by weight of PETP and 25% to 30% by weight of CaCO₃

TABLE 2
Texture grey value gradients

| | | | Dispersion | Area | |
|---|---|---|---|---|---|
| | Direction | based | (SD) | proportion | Goodness |
| Example No. | [degrees] | on | [degrees] | [%] | of fit |
| 1A | −93.64 | MD | 20.88 | 0.33 | 0.99 |
| 1B | −91.02 | MD | 17.23 | 0.38 | 0.99 |
| 2A | −93.56 | MD | 19.07 | 0.31 | 0.98 |
| 2B | −91.11 | MD | 16.15 | 0.37 | 0.99 |
| 3A | −0.95 | TD | 19.52 | 0.76 | 0.99 |
| 3B | −1.16 | TD | 12.83 | 0.79 | 0.99 |
| 4A | −91.05 | MD | 10.46 | 0.41 | 0.99 |
| 4B | −91.17 | MD | 15.91 | 0.4 | 0.99 |

TABLE 3
Variation of the texture grey values

| Example No. | SD in TD | SD in MD | SD of TD/MD |
|---|---|---|---|
| 1A | 12.1 | 4.4 | 2.8 |
| 1B | 9.0 | 3.6 | 2.5 |
| 2A | 14.8 | 4.3 | 3.4 |
| 2B | 9.8 | 3.9 | 2.5 |
| 3A | 5.6 | 3.6 | 1.6 |
| 3B | 5.7 | 3.8 | 1.5 |
| 4A | 6.6 | 2.6 | 2.5 |
| 4B | 6.4 | 5.2 | 1.2 |

### Test Methods

The test methods used to characterize the film according to the invention and the first and second polymeric materials of the matrix are described hereinafter.

The visual texture of the at least one decorative layer containing striations of films according to the invention is characterized mathematically or statistically with the aid of software-assisted image analysis methods. For this purpose, a rectangular piece of film having an area of ≥100 cm² and a minimum edge length of ≥8 cm is first cut out of a film according to the invention. The sections are run parallel to transverse and machine direction, such that two edges of the rectangular piece of film run parallel to transverse direction and two parallel to machine direction. A digital image of the rectangular piece of film is taken with the aid of a flatbed scanner having an optical resolution of 600 dpi (=42.3 μm). Standard copiers and flatbed scanners are equipped with optics having a resolution of up to 600 dpi. In order to precisely capture the flowing colour or luminance transitions (brightness transitions) of the optical texture of films according to the invention, however, a resolution of 80 dpi (=318 μm) is found to be entirely adequate. In the case of an optical resolution of 80 dpi, the digital image of a piece of film having an area of 400 cm² comprises about 396 800 pixels. In order to assure high image quality and trueness of reproduction, the pieces of film are first scanned with an optical resolution of 600 dpi. The high-resolution scanned images are subsequently scaled down to a resolution of 80 dpi with the aid of image processing software, for example Gimp (https://www.gimp.org/). In the scaling from 600 dpi to 80 dpi, the colour channels or RGB colour values of the 80 dpi pixels are ascertained from the RGB values of the 600 dpi pixels by means of horizontal and vertical cubic interpolation. The image scaling does not impair the trueness of reproduction. There is no visually perceptible difference between a texture reproduced with 80 dpi and 600 dpi resolution.

If the digital image of the piece of film recorded with the scanner is in the form of a colour image, this is converted to a grey value image by assigning a grey value to each pixel according to its luminance or brightness Y. The luminance or brightness Y is calculated in accordance with the PAL or NTSC standard (ITU-R BT.601 conversion) and the MPEG standard by the formula

Y=0.299·R+0.587G+0.114·B (II)

from the colour values R (red), G (green) and B (blue) of the respective pixel (https://de.wikipedia.org/wiki/Luminanz). The conversion to a grey value image is undertaken with the aid of a graphics program, such as Gimp (https://www.gimp.org/), or image analysis software, such as ImageJ (https://imagej.nih.gov/ij/).

In the grey value image obtained, the grey value profiles often lines at right angles to machine direction and each of length about 18 cm or 567 pixels are evaluated and the standard deviation of the grey values of each grey value profile are calculated. The average of the ten values thus calculated for the standard deviation is then determined and used as a representative measure of the extent of the striations in the form of stripes in transverse direction.

The grey value profiles often lines parallel to machine direction and each of length about 18 cm or 567 pixels and the standard deviation of the grey values of each grey value profile are likewise calculated. The average of the ten values thus calculated for the standard deviation is then determined and used as a representative measure of the grey value scatter of the striations in the form of stripes in machine direction.

The image analysis software IMAGEJ® (Analyze Menu/Measure) is used for the analysis of the grey value profiles of the ten lines in each case that are parallel to machine and transverse direction and are about 18 cm in length.

Additionally determined is the directionality or statistical distribution of the luminance or grey value gradient of the visual texture. For this purpose, a rectangular image section with a size of about 20 cm×18 cm and about 630×567˜357 121 pixels from the grey value image of the rectangular piece of film is analysed. The rectangular section is chosen such that two of its edges run parallel to transverse direction and two parallel to machine direction. For each pixel P(i,j) of the rectangular image section, a component G_{T}(i,j) parallel to transverse direction and a component G_{M}(i,j) parallel to machine direction of the grey value gradient are calculated by convoluting an area centred around the pixel P(i,j) in question with 5×5=25 pixels P(k,l) where i−2≤k≤i+2 and j−2≤l≤j+2 with 5×5 Sobel operators S_{T} and S_{M} respectively. The mathematical formalism including the Sobel operators for the calculation of the components of the grey value gradient G_{T}(i,j) und G_{M}(i,j) is reproduced below, where the symbol “*” denotes the convolution operator:

$$\begin{matrix}{G}_{T} ( i , j ) = {S}_{T} * P ( i , j ) = {\sum }_{k , l = - 2}^{+ 2} {S}_{T} ( k , l ) \cdot P ( i - k , j - l ) & ( III ) \\ {G}_{M} ( i , j ) = {S}_{M} * P ( i , j ) = {\sum }_{k , l = - 2}^{+ 2} {S}_{M} ( k , l ) \cdot P ( i - k , j - l ) & ( IV ) \\ {S}_{T} = ( \begin{matrix}1 & 2 & 0 & - 2 & - 1 \\ 4 & 8 & 0 & - 8 & - 4 \\ 6 & 12 & 0 & - 12 & - 6 \\ 4 & 8 & 0 & - 8 & - 4 \\ 1 & 2 & 0 & - 2 & - 1\end{matrix} ) & ( V ) \\ {S}_{M} = ( \begin{matrix}- 1 & - 4 & - 6 & - 4 & - 1 \\ - 2 & - 8 & - 12 & - 8 & - 2 \\ 0 & 0 & 0 & 0 & 0 \\ 2 & 8 & 12 & 8 & 2 \\ 1 & 4 & 6 & 4 & 1\end{matrix} ) & ( VI )\end{matrix}$$

In the case of the above Sobel operators, it is a prerequisite that the horizontal edges of the image section analysed are oriented parallel to transverse direction and the vertical edges parallel to machine direction.

At the edges of the image section analysed, the components of the grey value gradient G_{T}(i,j) and G_{M}(i,j) are calculated using the edge pixels; in other words, it is assumed that the two pixels that are adjacent to an edge pixel in transverse or machine direction and are outside the image section have the same grey value as the edge pixel in question. It should be noted here that, in the case of an image section having a size of about 1180×1180 pixels, the contribution of the two or four edge pixels is negligible.

The components of the grey value gradient G_{T}(i,j) and G_{M}(i,j) are used to calculate the direction or angle Θ(i,j) of the grey value gradient of each pixel P(i,j) based on the transverse direction by the formula

Θ(i,j)=a tan 2(G_{T}(i,j),G_{M}(i,j)) (VII)

The contribution W(i,j) of the respective pixel P(i,j) is weighted by the square of the contribution of the grey value gradient G_{T}²(i,j)+G_{M}²(i,j), i.e.

$$W ( i , j ) = \frac{{G}_{T}^{2} ( i , j ) + {G}_{M}^{2} ( i , j )}{{\sum }_{i , j} [ {G}_{T}^{2} ( i , j ) + {G}_{M}^{2} ( i , j ) ]} \qquad ( VIII )$$

Finally, the contributions or weightings W(i,j) are represented as a function of the angle Θ(i,j) in the manner of a frequency distribution. It is found here that the grey value gradient is oriented essentially parallel to transverse direction for a considerable portion of the pixels P(i,j). The directionality and standard deviation thereof are determined using the more or less Gaussian distribution of the weightings W(i,j) about transverse direction. For this purpose, by means of nonlinear regression, a Gaussian curve is fitted to the frequency distribution of the weightings W(i,j) as a function of the angle Θ(i,j). A measure calculated for the directionality is the area beneath the fitted Gaussian curve in an area centred around the maximum of the Gaussian curve with a width of two standard deviations.

The above-elucidated calculations of the directionality of the visual texture are conducted with the aid of the image analysis software IMAGEJ® (Analyze Menu/Directionality). A detailed description of the working of the analysis function “Directionality” can be found on the Internet at the address https//imagej.net/Directionality.

The software-assisted analysis of the directionality of films according to the invention is illustrated in FIGS. 6, 8, 10 and 12. The time taken for the user-led analysis of the visual texture of a piece of film with the aid of the IMAGEJ® image analysis software is a few minutes.

The density of the film according to the invention is determined to DIN EN ISO 1183:2005 and the thickness to DIN 53370:2006.

The melt mass flow rate or melt flow index MFI of the polymeric materials is generally measured according to DIN EN ISO 1133-1:2012-03, and in the case of heat-sensitive polymeric materials according to DIN EN ISO 1133-2:2012-03. Table 4 below shows the measurement parameters used in the measurement of the melt mass flow rate MFI according to DIN EN ISO 1133-1:2012-03 and DIN EN ISO 1133-2:2012-03.

TABLE 4
Melt mass flow rate measurement conditions

| Polymer | Testing temperature | Test load | |
|---|---|---|---|
| Polystyrene¹ | 200° C. | 5 | kg |
| Styrene-butadiene copolymer | | | |
| Polyethylene | 190° C. | 2.16 | kg |
| Polypropylene² | | | |
| Polystyrene³ | 230° C. | 2.16 | kg |
| Polypropylene⁴ | | | |
| PETG | | | |
| PETP⁵ | | | |
| APET | | | |
| Cycloolefin copolymer | 260° C. | 2.16 | kg |

¹for MFI values in the range from 20 to 60 g/10 min
²for MFI values in the range from 60 to 100 g/10 min
³for MFI values in the range from 1 to 20 g/10 min
⁴for MFI values in the range from 1 to 60 g/10 min
⁵for rapidly crystallizing PETP measurement of intrinsic viscosity

In the case of rapidly crystallizing polyester of the PETP type, intrinsic viscosity is measured according to DIN EN ISO 1628-5:2015-05 and converted to a melt mass flow rate by the formula

MFI=9+7322·10^{-3.17·IV}

in which IV denotes the intrinsic viscosity in the unit [dl/g] (decilitre/g) and MFI the melt mass flow rate in the unit [g/10 min] at a testing temperature of 230° C. and a test load of 2.16 kg.

The average roughness Rₐ, maximum roughness R_{z} and maximum waviness Wₜ of the surface of the decorative layer containing striations in the film according to the invention is determined by means of a tactile profilometer, for example with an instrument of the “Hommel-Etamic W20” type from Jenoptik or of the “Perthometer S2/PGK” type from Mahr. The measurement is in accordance with the standards DIN EN ISO 4287:2010 and DIN EN ISO 16610-21:2013. In this case, a probe tip having a radius of less than 5 μm is used. In each roughness measurement, a scan zone 1,r 25 mm is scanned. The limiting threshold λ_{c} used in the low-pass filter for the separation of roughness and waviness according to DIN EN ISO 16610-21:2013 is a value of λ_{c}=2.5 mm. The average roughness is calculated by the formula

$${R}_{a} = \frac{1}{{l}_{r}} {\int }_{0}^{{l}_{r}} \vert Z ( x ) \vert dx \qquad ( IX )$$

where Z(x) is the measured deflection at right angles to the film surface (depth or height) as a function of the scanning position x.

If the decorative layer containing striations does not form one of the two surfaces of the film in the film according to the invention, the average roughness Rₐ, maximum roughness R_{z} and maximum waviness Wₜ are determined from a light microscope image of a film section at right angles to the film surface. The film section is executed by means of a microtome. In order to record a digital image of the film section, a light microscope equipped with digital camera is used. If the digital image of the piece of film recorded with the light microscope is a colour image, this is converted to a grey value image by assigning a grey value to each pixel according to its luminance or brightness Y. The luminance or brightness Y is calculated in accordance with the PAL or NTSC standard (ITU-R BT.601 conversion) and the MPEG standard by the formula

Y=0.299·R+0.587·G+0.114·B (II)

from the colour values R (red), G (green) and B (blue) of the respective pixel (https://de.wikipedia.org/wiki/Luminanz). The conversion to a grey value image is undertaken with the aid of a graphics program, such as Gimp (https://www.gimp.org/), or image analysis software, such as ImageJ (https//imagej.nih.gov/ij/).

In the digitalized grey value image of the film section, the boundary or limit of the decorative layer containing striations is characterized by a jump in contrast and is extracted as a curve by means of image analysis software, for example ImageJ (https://imagej.nih.gov/ij/). A standard edge detection filter (https://de.wikipedia.org/wiki/Kantendetektion), especially a 3×3 Sobel operator, is used for the digital extraction. After employment of the edge detection filter, the image is binarized by threshold formation such that the edge of the decorative layer containing striations is in the form of a curve of black (white) pixels on a white (black) background. This curve is then used to determine, according to the standards DIN EN ISO 4287:2010 and DIN EN ISO 16610-21:2013, the average roughness Rₐ, maximum roughness R_{z} and maximum waviness Wₜ.

In order to determine the optical transmission of the matrix of the decorative layer containing striations of a film according to the invention, the first polymeric material is used to produce a monolayer reference film by the same production method as the film according to the invention. The thickness d_{ref} of the monolayer reference film of the first polymeric material is measured according to DIN 53370:2006.

The term “optical transmittance” as used in the present invention refers to the average total transmittance Tₐ. The total transmittance T(λ) of the monolayer reference film as a function of the wavelength λ is determined according to DIN EN ISO 13468-2:2006-07 using a spectrophotometer with an Ulbricht sphere for the detection of the light transmitted (for example, a Shimadzu UV-3600 Plus spectrometer with ISR-1503 Ulbricht sphere having diameter 150 mm or a “haze-gard i” transparency measurement system from BYK-Gardner GmbH is used). For the measurement of total transmittance T(λ), a collimated beam of incident light with intensity I₀(λ) is directed onto a surface of the reference film at a normal or perpendicular direction. The incident beam of light is partly reflected at the outer and inner surfaces of the reference film. The sum total of the reflected intensities is referred to as I_{R}(λ). In the case of transmission of the incident light beam in the reference film, further intensities I_{A}(λ), I_{FS}(λ) and I_{BS}(λ) of the incident light beam are emitted, owing to absorption (A) and forward scatter (FS) or backward scatter (BS). Because an Ulbricht sphere is being used for detection of the transmitted light, the forward-scattered light intensity I_{FS}(λ) is recorded by the spectrophotometer. Accordingly, the total transmittance measured T(λ) can be described by the following equation:

$$T ( λ ) = c \frac{[ {I}_{0} ( λ ) - {I}_{R} ( λ ) - {I}_{BS} ( λ ) ]}{{I}_{0} ( λ )} \qquad ( X )$$

in which c denotes a factor which is determined by careful calibration of the spectrophotometer, for example by measuring the total transmittance without sample. The optical transmittance, i.e. the average total transmittance Tₐ, is obtained by averaging of T(λ) over the visible wavelength range from 380 to 780 nm, according to the equation

$${T}_{a} = \frac{1}{400 nm} {\int }_{380 nm}^{780 nm} T ( λ ) d λ \qquad ( XI )$$

The optical transmittance of the matrix of the decorative layer containing striations in a film according to the invention is determined by converting the optical transmittance of the monolayer reference film of thickness d_{ref}—measured as described above—by the Lambert-Beer law to the thickness d_{L} of the decorative layer containing striations. According to the Lambert-Beer law, transmittance through a body can be described by the relationship

T=exp(−α·d) (XII)

where α denotes the coefficient of absorption and d the optical path length or, in the case of perpendicular incidence of light, the thickness of the body. The optical transmittance and thickness d_{ref} of the monolayer reference film are used to calculate the coefficient of absorption α. The coefficient of absorption α and the thickness d_{L} are then inserted into the Lambert-Beer formula (11) in order to determine the optical transmittance of the matrix of the decorative layer containing striations.

The thickness d_{L} of the decorative layer containing striations, in the case of a monolayer film, is measured according to DIN 53370:2006. If the film according to the invention comprises multiple layers, the thickness d_{L} is determined by means of a light-optical microscope using a cross-sectional sample of the film prepared with a microtome.

That which is claimed:

1. Mono- or multilayer film comprising at least one decorative layer comprising a matrix comprising of a first polymeric material and striations of a second polymeric material embedded into the matrix.

2. Film according to claim 1, wherein the volume ratio of the striations to the matrix is 0.5% to 15% by volume.

3. Film according to claim 1, wherein the matrix of the decorative layer containing striations is transparent.

4. Film according to claim 1, wherein the second polymeric material of the decorative layer containing striations comprises a dye or colour pigments.

5. Film according to claim 1, wherein the first and second materials of the decorative layer contain striations have respective melt mass flow rates MFI₁ and MFI₂ and
0.2≤2|MFI₁−MFI₂|/(MFI₁+MFI₂)≤2.0.

6. Film according to claim 1, wherein the first polymeric material of the decorative layer containing striations comprises a dye or colour pigments.

7. Film according to claim 1, wherein the at least one decorative layer containing striations comprises a third polymeric material having a melt mass flow rate MFI₃ and
0.2≤2|MFI₁−MFI₃|/(MFI₁+MFI₃)≤2.0.

8. Film according to claim 1, wherein the at least one layer containing striations has a visual texture having a luminance in transverse and machine direction of the film that has respective standard deviations S_{T} and S_{M}, where the ratio S_{T}/S_{M}≥1.2.

9. Film according to claim 1, wherein the at least one layer containing striations has a visual texture with a directionality of ≥20% within an angle range of ±30° about the transverse direction.

10. Film according to claim 1, wherein the at least one layer containing striations has at least one surface or interface having an average roughness Rₐ≤10 μm.

11. Process for producing a mono- or multilayer film as claimed in claim 1, comprising the steps of
(a) providing a first polymeric material having a melt mass flow rate MFI₁;
(b) providing a second polymeric material having a melt mass flow rate MFI₂, where 0.2≤2|MFI₁−MFI₂|/(MFI₁+MFI₂)≤2.0;
(c) feeding the first and second polymeric materials in a volume ratio of 100:0.5 to 100:15 into an extruder or a kneading unit;
(d) plastifying the first and second polymeric materials in the extruder or kneading unit;
(e) forming a mono- or multilayer film, wherein at least one layer, comprising the first and second polymeric materials, of the film is formed by extrusion, coextrusion and/or calendering.

12. Process according to claim 11, wherein the first polymeric material is transparent.

13. Process according to claim 11, wherein the second polymeric material comprises a dye or colour pigments.

14. Process according to claim 11, wherein the first polymeric material comprises a dye or colour pigments.

15. Mono- or multilayer film, wherein the film has been produced by a process according to claim 11.
